(19) United States
(12) Patent Application Publication
(10) Pub. No.: US 2012/0154681 A1
(43) Pub. Date: Jun. 21, 2012

(54) DIAPHRAGM CONTROL CIRCUIT, PROJECTOR DEVICE, DIAPHRAGM CONTROL PROGRAM AND DIAPHRAGM CONTROL METHOD

(76) Inventor: Takeshi Morimoto, Tokyo (JP)

(21) Appl. No.: 13/384,210

(22) PCT Filed: Jul. 17, 2009
(86) PCT No.: PCT/JP2009/063003

§ 371 Date: Feb. 24, 2012

(51) Int. Cl. H04N 9/68; H04N 9/31

(52) U.S. Cl. 348/645; 348/744; 348/E09.025; 348/E09.053

(57) ABSTRACT

A video processing unit has a diaphragm control unit which uses a diaphragm to limit the light quantity emitted in accordance with information indicating the brightness of the supplied video signal. Here, the diaphragm control unit controls the open degree of the diaphragm in accordance with a difference between the open degree of the diaphragm detected by a diaphragm drive unit which detects the open degree of the diaphragm and a target open degree of the diaphragm based on the information indicating the brightness of the supplied video signal.

### TECHNICAL FIELD

The present invention relates to a diaphragm control circuit that controls the amount of light which is emitted in accordance with a supplied video signal, and to a projector device, a diaphragm control program, and a diaphragm control method.

### BACKGROUND ART

In a projector device, the amount of light from a light source is modulated using an optical modulator in accordance with a video signal supplied to the projector, and an image which is based on the video signal is displayed by changing the amount of light which is emitted. It is difficult to secure the required contrast ratio simply by adjusting the modulation factor of the light using an optical modulator. Technology exists in which, in order to raise the contrast ratio while compensating for an insufficient light modulation factor, either the amount of light which is supplied to the optical modulator, or the amount of light which is emitted from the optical modulator is controlled. This control of the amount of light is achieved by means of an optical system which is formed by a combination of a lens and a diaphragm, and a control section which adjusts the numerical aperture of this aperture (see, for example, Patent document 1).

### [Documents of the Prior Art]

### [Patent Documents]

[Patent document 1] Japanese Unexamined Patent Application, First Publication (JP-A) No. 2006-285089

### DISCLOSURE OF INVENTION

### Problem to be Solved by the Invention

However, in the technology described in Patent document 1 the amount of emitted light is adjusted in accordance with a supplied video signal, however, no mention is made of the responsiveness or stability if there is a change in the video signal.

Generally, if a displayed video image changes, then there is a sizable change in the level of the video signal. For example, if there is a large change in brightness so that a video image changes from a high-luminance video image to a low-luminance video image, then the brightness of the displayed screen changes so that the display appears unnatural.

The changing of the video signal is performed electrically so that the change occurs instantaneously, however, if the amount of light is controlled by using a diaphragm, then a mechanical response time is needed for the diaphragm to operate. This response time difference has an effect on the video display. If the responsiveness of the control of the numerical aperture is raised in order to shorten this response time, then the numerical aperture tracks even the smallest changes in the video signal, and if the changes are abrupt then shaking which is caused by hyper-responsiveness is generated and a prolonged time is needed until stability is restored. As a result, variations are generated in the amount of emitted light, and the problem arises that the quality of the displayed video images deteriorates.

The present invention was conceived in order to solve the above described problem, and it is an object thereof to provide a diaphragm control circuit, a projector device, a diaphragm control program, and a diaphragm control method that, while securing responsiveness that follows the track of a supplied video signal, secure stability in the amount of emitted light.

### Means for Solving the Problem

In order to solve the above described problem, a diaphragm control circuit according to the present invention includes a control unit that controls an open degree of a diaphragm at a speed which corresponds to a difference between a detected open degree of the diaphragm which is detected by an open degree detection unit and a target open degree of the diaphragm which is determined based on information showing a brightness of a supplied video signal in order to limit an amount of light which is emitted in response to the information showing the brightness of the supplied video signal by using the diaphragm.

### Effect of the Invention

According to the present invention, when the control section of a diaphragm control circuit uses a diaphragm portion in order to limit an amount of light which is emitted in accordance with information which shows the brightness of a supplied video signal, it controls the open degree of the diaphragm portion based on the speed which corresponds to the difference between a detected open degree of the diaphragm portion which is detected by an open degree detection unit which detects the open degree of the diaphragm portion, and a target open degree for the diaphragm portion which is determined based on the information showing the brightness of the supplied video signal.

As a result, because the control unit is able to limit the amount of emitted light by adjusting the open degree of the diaphragm portion at a speed that corresponds to the difference between the detected open degree and the target open degree which is determined based on the brightness of the video signal, it is possible to secure stability in the amount of light that is emitted from the diaphragm portion while also securing a responsiveness that is able to track a supplied video signal.

### BRIEF DESCRIPTION OF THE DRAWINGS

FIG. 1 is a schematic block diagram of a projector device according to the present embodiment.

FIG. 2 is a block diagram of a control system that controls the amount of light which is emitted from the projector device of the same embodiment.

FIG. 3 is a view showing a diaphragm position table in the same embodiment.

FIG. 4 is a view showing a motor speed table which shows relationships between the amount of movement in a diaphragm position and the motor speed in the same embodiment.

FIG. 5 is a timing chart showing the movement of a diaphragm position in the same embodiment.

FIG. 6 is a flowchart showing a processing sequence for diaphragm position control in the same embodiment.

### EMBODIMENTS FOR CARRYING OUT THE INVENTION

Hereinafter, a projector device according to an embodiment of the present invention will be described with reference made to the drawings.

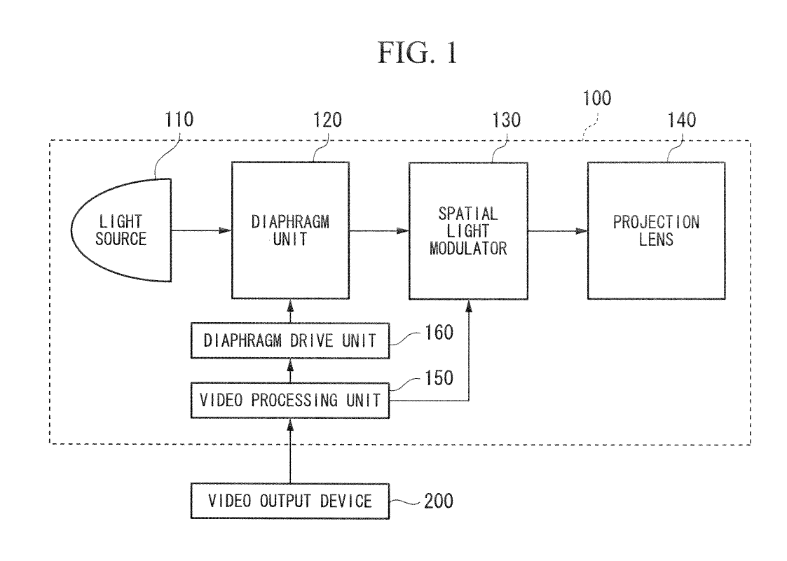

FIG. 1 is a schematic block diagram of a projector device according to the present embodiment.

A projector device 100 receives video signals from a video output device 200 connected thereto and, based on the video signals, adjusts the intensity of light emitted from the projector device 100.

The projector device 100 shown in this drawing is provided with a light source 110, a diaphragm unit 120, a spatial light modulator 130, a projection lens 140, a video processing unit 150, and a diaphragm drive unit 160.

The light source 110 emits the light which is to be projected from the projector device 100, and is formed, for example, by a lamp or LED (Light Emitting Diode) or the like. The diaphragm unit 120 adjusts the amount of light from the light source 110 by shading a portion of the optical path of the light that is emitted from this light source. The range of the shading of the optical path by the diaphragm unit 120 can be set in stages and, in the present embodiment, the shading can be set to 100 stages. The amount of light can be adjusted in accordance with this setting. The spatial light modulator 130 adjusts the amount of light and the polarization and the like of the light which is emitted from the light source 110, and modulates the intensity of the light by means of a supplied video signal. Examples of the optical elements used to form the spatial light modulator 130 include liquid crystal display elements and DMD (Digital Mirror Devices) and the like. The projection lens 140 is an optical component that includes a lens which is used to form an image of the projection image created by the emitted light on a screen.

Based on video signals which are supplied from the video output device 200, the video processing unit 150 causes the diaphragm unit 120 to adjust the amount of light shading by controlling the range of the shading of the optical path in the diaphragm unit 120, and also causes the spatial light modulator 130 to adjust the intensity modulation of the light that forms an image in the spatial light modulator 130 by controlling the intensity modulation of the light in the spatial light modulator 130.

In accordance with motor control signals that are output from the video processing unit 150, the diaphragm drive unit 160 outputs drive signals that are used to drive a motor 122 of the diaphragm unit 120.

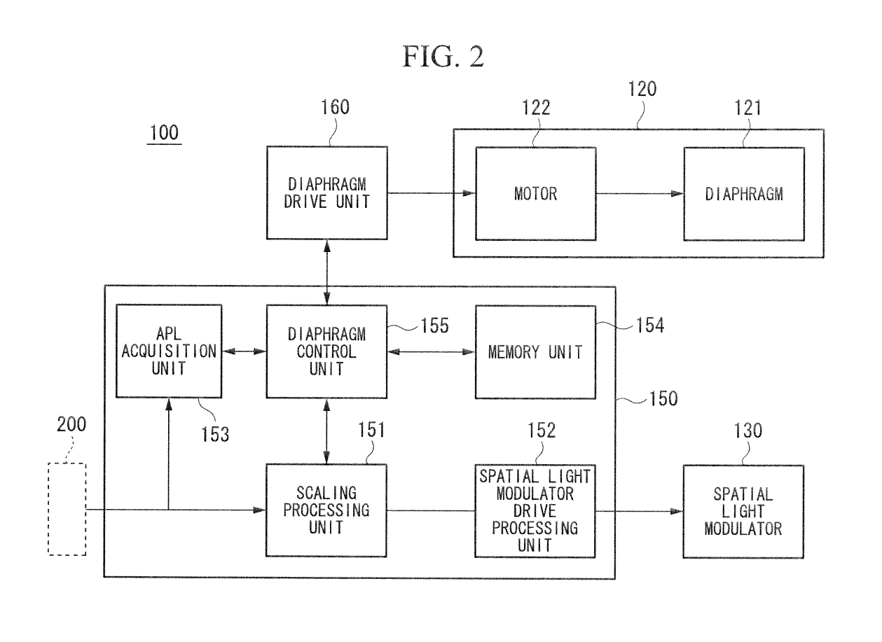

FIG. 2 is a block diagram of a control system that controls the amount of light which is emitted from the projector device.

The projector device 100 shown in this drawing is provided with the diaphragm unit 120, the spatial light modulator 130, the video processing unit 150, and the diaphragm drive unit 160 as a control system that controls the amount of light which is emitted. The same symbols are used for structure that is the same as in FIG. 1.

The diaphragm unit 120 is provided with a diaphragm 121 and a motor 122.

The diaphragm 121 is a main body section of a ‘diaphragm’ that adjusts the amount of light which is emitted from the light source 110 (FIG. 1). The diaphragm 121 is formed by a plurality of movable vanes that are mechanically interlocked with the shaft of the motor 122. The movable vanes operate in accordance with the rotation of the motor 122, and the open degree (i.e., the numerical aperture of he diaphragm which corresponds to the diaphragm position is fixed.

The motor 122 controls the diaphragm open degree of the diaphragm 121. The motor 122 is driven in accordance with the amount of control that is supplied from the diaphragm drive unit 160. The movable vanes of the diaphragm 121 are operated when rotation from the rotation shaft of the motor 122 is transmitted thereto, resulting in the open degree of the diaphragm 121 being adjusted. The motor 122 also stores motor rotation positions that correspond to diaphragm positions which show the open degree of the diaphragm 121.

The video processing unit 150 of the projector device 100 is provided with a scaling processing unit 151, a spatial light modulator drive processing unit 152, an APL acquisition unit 153, a memory unit 154, and a diaphragm control unit 155.

In the video processing unit 150, the scaling processing unit 151 performs conversion processing to convert the resolution of supplied video signals to the resolution required for internal processing. The scaling processing unit 151 creates synchronization signals that are synchronized with the timings of the supplied video signals, and sampling processing which is performed on video signals that are supplied in synchronization with these synchronization signals is performed. The scaling processing unit 151 performs scaling conversion to convert supplied video signals to a predetermined resolution based on the sampled information.

The spatial light modulator drive processing unit 152 outputs signals that drive the liquid crystal display elements (or DMD) which make up the spatial light modulator 130 based on the signals that are converted by the scaling processing unit 151.

The APL acquisition unit 153 acquires the APL (Average Picture Level) of video signals that are supplied from the video output device 200. The APL acquisition unit 153 performs APL calculation processing for each frame of a video signal, and outputs the APL information derived from each frame to the diaphragm control unit 155.

The memory unit 154 stores previously determined data such as information in table form that is referred to in the conversion processing, and threshold value information that is used as a reference in the determination processing, and the like. In addition, the memory unit 154 serves as a storage unit in which are located storage areas that temporarily store variables which are referred to in the calculation processing and the like. The memory unit 154 also stores a program that causes a computer which is contained in the diaphragm control unit 155 to operate.

The diaphragm control unit 155 acquires APL information from the APL acquisition unit 153, and refers to the data stored in the memory unit 154, and also outputs motor control signals to the diaphragm drive unit 160, and, in addition, controls each section of the projector device 100. Furthermore, the diaphragm control unit 155 uses information about the motor rotation position which is supplied from the diaphragm drive unit 160 to acquire the diaphragm position of the diaphragm 121 in that state.

The diaphragm drive unit 160 receives motor control signals which are output from the diaphragm control unit 155, and controls the rotation direction and the rotation speed of the motor 122. Moreover, the diaphragm drive unit 160 also refers to the motor rotation position, which is stored in the motor 122 and is used when a reference is made to the diaphragm position of the diaphragm 121, and then supplies this to the diaphragm control unit 155.

The diaphragm control method of the present embodiment will now be described eference made to the drawings.

As is shown in FIG. 2, the APL 153 constantly calculates brightness information Applied video signals. In the present embodiment, the description uses the APL as an example, however, the information may also show a different brightness from the APL such as the luminance distribution (i.e., a histogram) of the video signal or the like.

Based on the brightness information detected by the APL acquisition unit 153, the diaphragm control unit 155 outputs a control signal to the diaphragm drive unit 160, and operates the motor 122 so as to drive the diaphragm 121. Basically, the diaphragm control unit 155 performs control so as to narrow the diaphragm 121 when the APL of an supplied video signal is low, and so as to open the diaphragm 121 when the APL is high.

Here, the diaphragm control unit 155 defines a diaphragm position table that determines the open degree, namely, the diaphragm position of the diaphragm 121 in accordance with the value of the APL.

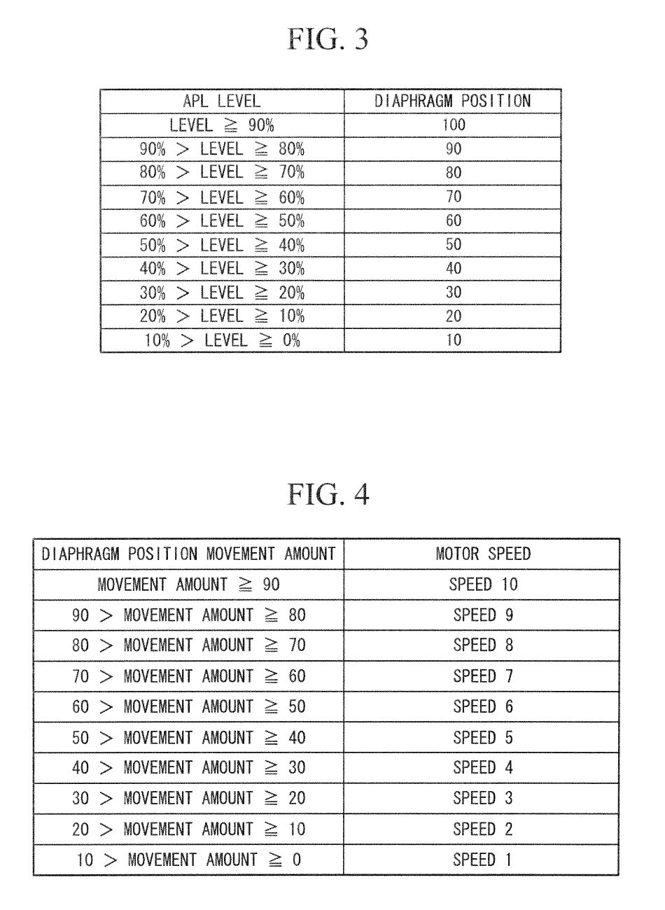

FIG. 3 is a view showing a diaphragm position table.

In the diaphragm position table shown in FIG. 3, it is possible to refer to the diaphragm position using the APL level as a key. The APL level is a value that is calculated based on a video signal which is supplied to the APL acquisition unit 153, and that corresponds to the APL of that particular video signal. An APL level of 100% indicates a state in which the entire screen shows a white video image, while an APL level of 0% indicates a state in which the entire screen shows a black video image. If the level of the video signal is within a regular voltage range, then the detected APL level is a value of between 0% and 100%. In addition, a diaphragm position of 100 indicates a state in which the diaphragm 121 is fully open, and indicates a state in which 100% of the amount of light from the light source 110 is emitted to the spatial light modulator 130. In contrast, a diaphragm position of 10 indicates a state in which the diaphragm 121 has been narrowed down so that the amount of light transmitted to the spatial light modulator 130 is 10% of that when the diaphragm 121 is fully open.

In the example shown in the present embodiment, diaphragm control is performed using diaphragm positions that have been set to 10 stages in accordance with the APL. Namely, if the APL level is 90% or more, the diaphragm position is set to 100. If the APL level is less than 90% but not less than 80%, the diaphragm position is set to 90. If the APL level is less than 80% but not less than 70%, the diaphragm position is set to 80. If the APL level is less than 70% but not less than 60%, the diaphragm position is set to 70. If the APL level is less than 60% but not less than 50%, the diaphragm position is set to 60. If the APL level is less than 50% but not less than 40%, the diaphragm position is set to 50. If the APL level is less than 40% but not less than 30%, the diaphragm position is set to 40. If the APL level is less than 30% but not less than 20%, the diaphragm position is set to 30. If the APL level is less than 20% but not less than 10%, the diaphragm position is set to 20. If the APL level is less than 10% but not less than 0%, the diaphragm position is set to 10.

Moreover, in the present embodiment, the speed of the motor 122 is change in accordance with the amount of movement of the diaphragm 121.

FIG. 4 is a view showing a motor speed table which shows relationships between the diaphragm position movement amount and the motor speed.

In the motor speed table shown in FIG. 4, using the diaphragm position movement amount as a key, it is possible to refer to the diaphragm movement speed, namely, to the rotation speed of the motor 122 selected in each particular case.

In the example shown in the present embodiment, diaphragm control is performed using motor speeds that have been set to 10 stages in accordance with the diaphragm position movement amount. Namely, if the diaphragm position movement amount is 90 or more, the motor speed is set to speed 10. If the diaphragm position movement amount is less than 90 but not less than 80, the motor speed is set to speed 9. If the diaphragm position movement amount is less than 80 but not less than 70, the motor speed is set to speed 8. If the diaphragm position movement amount is less than 70 but not less than 60, the motor peed is set to speed 7. If the diaphragm position movement amount is less than 60 but not less than 50, the motor speed is set to speed 6. If the diaphragm position movement amount is less than 50 but not less than 40, the motor speed is set to speed 5. If the diaphragm position movement amount is less than 40 but not less than 30, the motor speed is set to speed 4. If the diaphragm position movement amount is less than 30 but not less than 20, the motor speed is set to speed 3. If the diaphragm position movement amount is less than 20 but not less than 10, the motor speed is set to speed 2. If the diaphragm position movement amount is less than 10 but is greater than 0, the motor speed is set to speed 1.

The motor speed is set to 10 stages from speed 1 through to speed 10, and is set such that the greater the amount of movement in the diaphragm position, the faster the movement speed. Namely, speed 1 is the slowest, and speed 10 is the fastest. Note that when the amount of movement in the diaphragm position which is derived by referring to the diaphragm position table is 0, then no movement in the diaphragm position is necessary. In this case, the diaphragm control unit 155 stops the motor 122 without rotating it.

For example, if an APL level that corresponds to the APL of a supplied video signal is 15%, then by referring to the diaphragm position table shown in FIG. 3, it can be seen that the corresponding diaphragm position is 20. This diaphragm position 20 is taken as the current diaphragm position. Thereafter, if the APL changes in conjunction with changes in the image so that the APL level reaches 85%, then the diaphragm position changes to 90. This diaphragm position of 90 indicates a new target diaphragm position to which the diaphragm position is altered when the proper diaphragm position changes in conjunction with changes in the image. The amount of movement in the diaphragm position from a diaphragm position of 20 to a diaphragm position of 90 is 70. Referring to motor speed table shown in FIG. 4, speed 8 is selected as the motor speed which corresponds to the diaphragm position movement amount of 70. The motor speeds range from speed 1 through to speed 10, and the greater the amount of movement, the faster the speed. As a result of this, it is possible to shorten the time required to adjust the diaphragm 121 even when there has been a sizable change in the video signal.

It is desirable for changes in the supplied video signal to be reflected instantly in the position of the diaphragm, however, if the diaphragm position moves at high-speed even when there is only a small change in the APL, then the change in the amount of light becomes conspicuous and creates a visual distraction.

As is shown in the motor speed table in FIG. 4, the diaphragm control unit 155 changes the speed of the motor in accordance with the amount of movement in the diaphragm position such that the motor speed is correspondingly slower as the amount of movement in the diaphragm position becomes smaller, and when there is only a small change in the APL, the diaphragm is moved at low speed. Moreover, by changing the position of the diaphragm 121 in stages, there is only a small change in the APL so that the diaphragm position is determined to still remain the same, the diaphragm control unit 155 does not change the open degree of the diaphragm 121. As a result of this, when video images in which there is only a small change in brightness are displayed, the video processing unit 150 is able to avoid the amount of emitted light being changed and consequently causing the brightness of the displayed images to frequently change.

The information in the diaphragm position table shown in FIG. 3 and in the motor speed table shown in FIG. 4 is stored in the memory unit 154. The diaphragm control unit 155 which has acquired APL information from the APL acquisition unit 153 refers to the memory unit 154, and transmits a motor control signal which includes control data to the diaphragm drive unit 160 in accordance with the amount of change in the APL.

The movement in the diaphragm position which follows changes in the video signal will now be described with reference made to a timing chart.

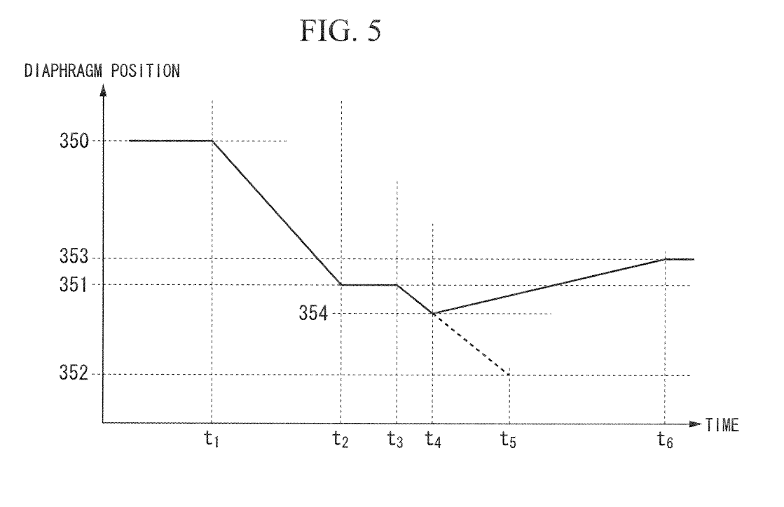

FIG. 5 is a timing chart showing movement of the diaphragm position.

The vertical axis in FIG. 5 shows the diaphragm position which is based on a supplied video signal. The higher the value of the vertical axis, the higher the open degree to which the diaphragm 121 is opened. The horizontal axis shows elapsed time.

In the present embodiment, the diaphragm 121 is controlled in accordance with changes in the APL of a supplied video signal. FIG. 5 shows a passage in which the APL changes three times in accordance with changes in the video signal, and in which the diaphragm position of the diaphragm 121 moves in conjunction with these changes, and the open degree thereof also changes.

An initial position 350 which shows the initial state of the diaphragm position shows a state in which the diaphragm 121 is fully open. Namely, the diaphragm position is 100. The slope of the graph shows the speed at which the diaphragm position is moved, namely, the speed at which the open degree of the diaphragm is changed. The steeper the slope, the faster the movement of the diaphragm position. Namely, the steeper the slope, the greater the change in the open degree.

The APL of a supplied video signal is determined repeatedly by the APL acquisition unit 153.

Firstly, it is assumed that the APL of the video signal changes at the timing t₁ from an initial state in which the supplied video images present a white display to a decreased state in which the video images have changed to dark video images. At the timing t₁, the APL acquisition unit 153 acquires the APL of that video signal, and performs determination processing so that it is determined that the APL of that video signal has decreased. Based on the APL detected by the APL acquisition unit 153 at the timing t₁, the diaphragm control unit 155 refers to the diaphragm position table shown in FIG. 3, and the diaphragm position which it consequently derives becomes the movement position 351 which is targeted for control. The diaphragm control unit 155 controls the diaphragm position of the diaphragm 121 such that this is moved from the initial position 350 to the movement position 351. In the movement at this time, the diaphragm control unit 155 refers to the motor speed table shown in FIG. 4, and causes the motor 122 to rotate at the motor speed which it consequently derives therefrom. When the diaphragm position reaches the movement position 351, the diaphragm control unit 155 stops the rotation of the motor 122 (i.e., at the timing t₂). The diaphragm position of the diaphragm 121 is held in a state of being stopped at the movement position 351 until the next APL state determination is made.

It is now assumed that the video images supplied during this time have changed into even darker video images, and that the APL has decreased even further.

At the timing t₃, the APL acquisition unit 153 once again detects the state of the APL. Based on the APL detected by the APL acquisition unit 153 at the timing t₃, the diaphragm control unit 155 refers to the diaphragm position table shown in FIG. 3 and sets the diaphragm position thus derived as a movement position 352 which is then targeted for control. The diaphragm control unit 155 controls the diaphragm position of the diaphragm 121 such that it starts to move from the movement position 351 towards the movement position 352. In the movement at this time, the diaphragm control unit 155 refers to the motor speed table shown in FIG. 4, and causes the motor 122 to rotate at the motor speed which it consequently derives therefrom.

Here, it is now assumed that, before the diaphragm position reaches the movement position 352, the APL changes so that the target diaphragm position also changes. It is assumed that the video image supplied at this time has changed to a brighter video image than the APL determined at the timing t₁.

At the timing t₄, the APL acquisition unit 153 once again detects the state of the APL. At the timing t₄, the diaphragm position which was derived based on the detected APL forms a movement position 353 which is now targeted for control. This movement position 353 corresponds to a position where the open degree of the diaphragm 121 is set higher than at the movement position 351.

For example, even if the state of the APL is determined at the timing t₄, if there is no change in the APL during the movement of the diaphragm position to the movement position 352, the movement of the diaphragm position continues and reaches the movement position 352 at the timing t₅. However, in the present embodiment, because a change in the APL was detected at the timing t₄, the movement towards the movement position 352 that was started at the timing t₃ is interrupted at the timing t₄. Next, the diaphragm control unit 155 sets the newly set movement position 353 as the target for diaphragm position control, and starts performing control in order to move the diaphragm position of the diaphragm 121 to the movement position 353.

At the timing t₄, when the diaphragm control unit 155 decides the motor speed for the motor 122 to move the diaphragm position to the movement position 353, it refers to the diaphragm drive unit 160. Using this reference to the diaphragm drive unit 160, the diaphragm control unit 155 acquires from the diaphragm drive unit 160 the acquired position 354, which is the current diaphragm position.

The diaphragm control unit 155 calculates the amount of movement A in the diaphragm position in this case in accordance with Formula (1).

Amount of movement A in the diaphragm position=(movement position 353)−(acquired position 354) (1)

An amount of movement B in the diaphragm position which is obtained if the current diaphragm position was not able to be acquired is shown in Formula (2).

Amount of movement B in the diaphragm position=(movement position 353)−(movement position 352) (2)

What should be noted here is the fact that, in the state which exists at the timing t₄, the amount of movement A in the diaphragm position is a smaller value than the amount of movement B in the diaphragm position. Accordingly, the relationship shown in Formula (3) is established.

Amount of movement B in the diaphragm position>amount of movement A and the diaphragm position (3)

As is shown in the motor speed table (FIG. 4) which is referred to by the diaphragm control unit 155, the amount of movement in the diaphragm position and the motor speed are set such that the motor speed is slower as the amount of movement decreases. Because of this, the diaphragm control unit 155 selects a slow motor speed in the case of the amount of movement A in the diaphragm position which is a smaller amount of movement than the amount of movement B in the diaphragm position.

Even if variations in the video signal continue so that the APL is constantly moving up and down, by acquiring the current diaphragm position, the diaphragm control unit 155 does not have to constantly track the position of the diaphragm 121.

Next, the processing sequence of the diaphragm position control of the present embodiment will be described.

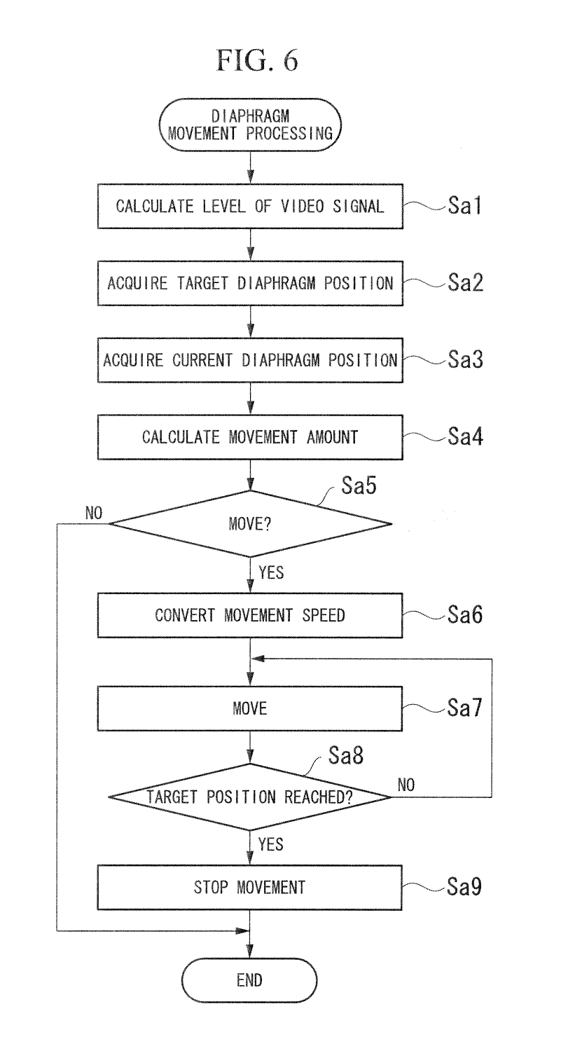

FIG. 6 is a flowchart showing the processing sequence of the diaphragm position control of the present embodiment.

The APL acquisition unit 153 calculates the level of a supplied video signal. This calculation of the level of a video signal is performed by determining the APL. The APL acquisition unit 153 supplies the determined APL into the diaphragm control unit 155 (step Sa1).

The diaphragm control unit 155 acquires a target diaphragm position to which the diaphragm position is to he moved based on the APL of the video signal which was supplied from the APL acquisition unit 153. Using the APL as a key, the diaphragm control unit 155 refers to the diaphragm position table (FIG. 3) which is stored in the memory unit 154, and acquires the target diaphragm position (step Sa2).

Next, the diaphragm control unit 155 acquires the current diaphragm position by referring to the diaphragm drive unit 160 to obtain information about the current diaphragm position (step Sa3).

In addition, the diaphragm control unit 155 calculates the amount of movement in the diaphragm position until it reaches the target diaphragm position from differential information which pertains to the difference between the previously acquired target diaphragm position and the current diaphragm position (step Sa4).

The diaphragm control unit 155 determines from the calculated amount of movement in the diaphragm position whether or not to move the diaphragm position. If it determines not to move the diaphragm position, then the current diaphragm movement processing is ended without the diaphragm position being moved (step Sa5).

If it is determined as a result of the determination in step Sa5 that the diaphragm position is to be moved, the diaphragm control unit 155 acquires the movement speed for the diaphragm position as the speed at which the driving motor 122 is to be rotated. Using the amount of movement in the diaphragm position as a key, the diaphragm control unit 155 refers to the motor speed table (FIG. 4) which is stored in the memory unit 154, and acquires a motor speed that corresponds to that amount of movement in the diaphragm position. The diaphragm control unit 155 then controls the movement speed of the diaphragm position of the diaphragm 121 which is connected to the motor 122 by driving the motor 122 based on this acquired motor speed (step Sa6).

Next, the diaphragm control unit 155 rotates the motor 122 in accordance with the acquired motor speed so as to move the diaphragm 121 towards the target diaphragm position (step Sa7).

The diaphragm control unit 155 then acquires the current diaphragm position by referring to the diaphragm drive unit 160, and determines whether or not the current diaphragm position has reached a predetermined target diaphragm position. The processing from step Sa7 is then repeated until, as a result of this determination, it is determined that the current diaphragm position has not reached the predetermined target diaphragm position (step Sa8).

When, as a result of the determination in step 8, it is determined that the current diaphragm position has reached the predetermined target diaphragm position, the diaphragm control unit 155 stops the driving of the motor 122, and ends the current diaphragm movement processing (step Sa9).

Note that, if the APL acquisition unit 153 detects that the supply of a video signal to the projector device 100 has stopped, or if the diaphragm control unit 155 detects an external signal interrupting the display of video images on the projector device 100, or if the settings of the diaphragm control unit 155 cause it to interrupt the controlling of the amount of light of the light source 110 executed by the diaphragm movement processing, then the diaphragm control unit 155 interrupts the above described diaphragm movement processing. In particular, conditions for interrupting the diaphragm movement processing have not been met, the diaphragm control unit 155 performs diaphragm movement processing at regular intervals at a cycle which is determined by a system timer provided in the diaphragm control unit 155.

Even if the target diaphragm position has not yet been reached and the movement of the diaphragm position in step Sa7 is still continuing, the diaphragm control unit 155 still receives interrupt processing in accordance with the cycle determined by the system timer, and starts the next diaphragm movement processing. If a different target diaphragm position is set by this newly started diaphragm movement processing, the diaphragm control unit 155 alters the target diaphragm position and movement speed to the newly acquired target diaphragm position and movement speed, and recommences the movement of the diaphragm position.

In this manner, in the above described diaphragm position control sequence, because the diaphragm movement processing is ended at the moment when the target diaphragm position is reached, it is possible to avoid any unnecessary tracking operations in the vicinity of the target position. Accordingly, because it is possible to avoid situations in which the diaphragm control unit 155 controls the diaphragm position by responding excessively to minute changes in a video signal, it is possible using the projector device 100 to achieve a display in which the amount of light is consistent and stable.

Note that according to the embodiment of the present invention, when the diaphragm control unit 155 uses the diaphragm 121 to limit the amount of light which is emitted in accordance with information showing the brightness of a supplied video the open degree of the diaphragm 121 is controlled by an open degree detecting unit which detects the open degree of the diaphragm 121 based on a speed which corresponds to the difference between the detected open degree of the diaphragm 121, and a target open degree for the diaphragm 121 that is determined based on information which shows the brightness of the supplied video signal.

As a result of this, because the diaphragm control unit 155 is able to limit he amount of emitted light by adjusting the open degree of the diaphragm 121 at a speed that corresponds to the difference between the detected open degree and the target open degree which is determined based on the brightness of the video signal, it is possible to secure stability in the amount of light that is emitted from the diaphragm portion while also securing a responsiveness that is able to track a supplied video signal.

Moreover, if a target open degree of the diaphragm 121 is newly detected based on information that shows the brightness of a supplied video signal during the same time as the open degree of the diaphragm 121 is being changed from the detected open degree of the diaphragm 121 to a target degree for the diaphragm 121 which has been determined based on information which shows the brightness of the supplied video signal, then the diaphragm control unit 155 described in the present embodiment controls the open degree of the diaphragm 121 in accordance with the newly detected target open degree.

Consequently, if a target open degree is newly detected based on the brightness of a supplied signal at the same time as the open degree of the diaphragm 121 is being changed from a detected open degree to a target open degree, because the diaphragm control unit 155 controls the open degree of the diaphragm 121 in accordance with the newly detected target open degree, it is possible to secure stability in the amount of light that is emitted from he diaphragm portion while also securing a responsiveness that is able to track a supplied video signal.

Moreover, the diaphragm control unit 155 described in the present embodiment controls the open degree of the diaphragm 121 such that the greater the difference between the detected open degree of the diaphragm 121 and the target open degree for the diaphragm 121, the faster the open degree is changed, while the smaller this difference, the slower the open degree is changed.

As a result, because the diaphragm control unit 155 controls the open degree of the diaphragm 121 such that the greater the difference between the detected open degree and the target open degree, the faster the open degree is changed, while the smaller this difference, the slower the open degree is changed, it is possible to secure stability in the amount of light that is emitted from the diaphragm portion while also securing a responsiveness that is able to track a supplied video signal.

Moreover, when the diaphragm control unit 155 described in the present embodiment detects that the detected open degree of the diaphragm 121 has reached the target open degree of the diaphragm 121 which is determined based on information which shows the brightness of a supplied video signal, it stops the adjustment of the open degree of the diaphragm 121.

As a result, because the diaphragm control unit 155 stops the adjustment of the open degree of the diaphragm 121 when it detects that the detected open degree has reached the target open degree, it is possible to secure stability in the amount of light that is emitted from the diaphragm portion while also securing a responsiveness that is able to track a supplied video signal.

Moreover, the APL acquisition section 153 described in the present embodiment derives an average value of information that shows the brightness of a supplied video signal based on that actual video signal. The diaphragm control unit 155 controls the open degree of the diaphragm 121 based on this average value of information that shows the brightness of a video signal.

As a result, because the diaphragm control unit 155 controls the open degree of the diaphragm 121 based on the average value of the brightness of a video signal which has been derived by the APL acquisition section 153, it is possible to secure stability in the amount of light that is emitted from the diaphragm portion while also securing a responsiveness that is able to track a supplied video signal.

Note that the present invention is not limited to the above described embodiment, and various modifications and the like are possible insofar as they do not depart from the spirit or scope of the present invention. It is also possible for a variety of types of level detection method to be applied to the detecting of the level of a video signal in the diaphragm control circuit of the present invention, and not only may the cycle of the level detection be set so as to be in synchronization with the frame cycle, but it may also be set to the field cycle or, alternatively, it may be set to a longer period than the frame cycle.

Moreover, the determination of the video signal level which is shown in FIG. 3, as well as the setting of the motor speed for moving the diaphragm which is shown in FIG. 4 are not particularly limited, and these may also be set to other constant numbers.

A computer system is provided within the above-described projector device 100. In addition, it is also possible for the above-described diaphragm position control processing steps to be stored in the form of a program on a computer-readable recording medium, and for the above-described processing to be performed as a result of this program being read and executed by the computer. Here, the term ‘computer-readable recording medium refers to magnetic disks, magneto-optical disks, CD-ROM, DVD-ROM, semiconductor memory, and the like. Furthermore, it is also possible for this computer program to be delivered to a computer via a communication network, and for the computer that receives this delivery to execute the particular program.

### Reference Symbols

100 Projector device
121 Diaphragm (Diaphragm portion)
150 Video processing unit (Diaphragm control circuit)
155 Diaphragm control unit (Control unit)

1. A diaphragm control circuit comprising:
a control unit that controls an open degree of a diaphragm at a speed which corresponds to a difference between a detected open degree of the diaphragm which is detected by an open degree detection unit and a target open degree of the diaphragm which is determined based on information showing a brightness of a supplied video signal in order to limit an amount of light which is emitted in response to the information showing the brightness of the supplied video signal by using the diaphragm.

2. The diaphragm control circuit according to claim 1, wherein, in a case that a new target open degree of the diaphragm is newly determined based on information showing the brightness of the supplied video signal during the period when the open degree of the diaphragm is being changed from the detected open degree of the diaphragm to the target open degree of the diaphragm, the control unit controls the open degree of the diaphragm in accordance with the new target open degree of the diaphragm.

3. The diaphragm control circuit according to claim 1, wherein the control unit controls the open degree of the diaphragm such that the greater the difference between the detected open degree of the diaphragm and the target open degree of the diaphragm, the faster the open degree is changed, while the smaller the difference, the slower the open degree is changed.

4. The diaphragm control circuit according to claim 1, wherein the control unit stops changing the open degree of the diaphragm when the diaphragm control unit detects that the detected open degree of the diaphragm has reached the target open degree of the diaphragm which is determined based on the information showing the brightness of the supplied video signal.

5. The diaphragm control circuit according to claim 1, further comprising an average picture level detection unit that derives an average value of the information showing the brightness of the supplied video signal, wherein the control unit controls the open degree of the diaphragm based on the average value.

6. A projector device comprising:
a control unit that controls an open degree of a diaphragm at a speed which corresponds to a difference between a detected open degree of the diaphragm which is detected by an open degree detection unit and a target open degree of the diaphragm which is determined based on information showing a brightness of a supplied video signal in order to limit an amount of light which is emitted in response to the information showing the brightness of the supplied video signal by using the diaphragm.

7. A computer readable recording medium storing a diaphragm control program that causes a computer to execute a processing sequence comprising:
controlling by a control unit an open degree of a diaphragm at a speed which corresponds to a difference between a detected open degree of the diaphragm which is detected by an open degree detection unit and a target open degree of the diaphragm which is determined based on information showing a brightness of a supplied video signal in order to limit an amount of light which is emitted in response to the information showing the brightness of the supplied video signal by using the diaphragm.

8. A diaphragm control method comprising:
controlling an open degree of a diaphragm at a speed which corresponds to a difference between a detected open degree of the diaphragm which is detected by an open degree detection unit and a target open degree of the diaphragm which is determined based on information showing a brightness of a supplied video signal in order to limit an amount of light which is emitted in response to the information showing the brightness of the supplied video signal by using the diaphragm.
